(19) United States
(12) Patent Application Publication
(10) Pub. No.: US 2008/0212846 A1
(43) Pub. Date: Sep. 4, 2008

(54) BIOMETRIC AUTHENTICATION USING BIOLOGIC TEMPLATES

(76) Inventors: Kazuya Yamamoto, Uda-city (JP); Shota Ichikawa, Nara-city (JP); Koji Hamaguchi, Osaka (JP)

Correspondence Address: OGILVIE LAW FIRM, 1320 EAST LAIRD AVENUE, SALT LAKE CITY, UT, 84105, US

(21) Appl. No.: 11/964,400

(22) Filed: Dec. 26, 2007

(30) Foreign Application Priority Data
Jan. 9, 2007 (JP) 2007001780

(51) Int. Cl. G06K 9/00

(52) U.S. Cl. 382/115

(57) ABSTRACT

Tools and techniques for biometric authentication obtain a biologic information input such as a fingerprint image, which is to be accepted or rejected as being input from an authentic user. Calculated matching scores show respective degrees of similarity between the biologic information input and several templates. The templates include a fixed registration biologic information template, as well as non-fixed learning biologic information templates which are subject to replacement.

### RELATED APPLICATION

The present application claims priority to Japanese Patent Application Serial No. JP2007-001780 filed Jan. 9, 2007, which is also incorporated herein to the extent permitted by law.

### BACKGROUND

Since various deals are made electronically, personal information is known by other people, and this often brings about serious consequences. In general, four-digit personal identification numbers are used for identity verification in automatic teller machines in banks, for example. However, once a personal identification number of a person is known by someone else, the person's deposit may possibly be withdrawn by someone else before the person notices. Such a problem is not limited to the banks' automatic teller machines. For example, when a personal computer is used, and a password to be used in the personal computer is known by someone other than the authorized person, then someone who is an identity thief may log on to a system, and this might bring serious consequences such as data destruction and leakage of data. Recently, various functions are added to mobile telephones and important information about individuals is frequently stored in the mobile telephones. For this reason, some mobile telephones have mechanisms that perform identity verification when one is using the mobile telephones.

In such conventional mechanisms, a password or a security code (hereinafter, “password or the like”) which can be known by an authentic owner is generally used. In a case where such a password or the like is used, once the password is known by someone else, they can easily spoof to overcome the mechanism.

As a technique for solving such problems, biometrics uses physical information (biologic information) such as fingerprints, irises, voice patterns and palm vein patterns which are unique to individuals. For example, fingerprints vary from person to person, and do not change over the years. For this reason, this information is recorded for confirmation of identities, and biologic information about a person who requests authentication is acquired and is compared to recorded information, so that the person can be verified. In such a manner, highly reliable authentication can be conducted. Particularly, identity theft becomes very difficult.

However, biometrics has problems. Here, the problems in a fingerprint authentication system are described as an example of problems in biometrics. Conventionally, in a fingerprint authentication system, fingerprint information to be a verification reference (hereinafter, “fingerprint template”) is retained in the system, and inputted fingerprint information is compared with the fingerprint template at the time of verifying. In general, at the time of registering the fingerprint template, fingerprint information is acquired at several times, and fingerprint information which seems to be optimal for verifying is used as the fingerprint template. At the time of verifying, fingerprint information acquired from a fingerprint image inputted through a fingerprint sensor is verified with the fingerprint template according to predetermined algorithm, so that identity verification is conducted.

Although fingerprints are unchanged permanently, actually, fingerprint sensors occasionally cannot recognize fingerprints due to skin dryness, skin moistness, wounds on fingers or the like. In this case, even a person with proper authority could not be appropriately verified, and consequently, this may prevent a wide use of the fingerprint authentication system. In order to avoid such a problem, an acceptance criterion may be relaxed at the time of authentication, but this may in turn cause identity theft.

In order to improve such a situation, various approaches are tried. An effective approach is to improve the performance of fingerprint sensors. Recently, some sensors can read unevenness of corium, not the surface skin of fingers, as a fingerprint. Such sensors are strongly resistant to external disturbing factors such as finger dryness and moistness, and thus are expected to greatly contribute to the improvement in operability of the fingerprint authentication system.

However, even sensors capable of reading corium cannot always conduct fingerprint verification, and there still remains a small number of fingerprints with which verifying cannot be properly performed.

In another approach, the fingerprint template is updated so that the rate of successful authentication with respect to external disturbing factors such as skin dryness and finger moistness can be heightened. Such a fingerprint verifying method is disclosed in Taizho Umezaki and three others, “An Effective Verification Method for Varying the quality of Fingerprint Images”, IEEJ Journal C, Jul. 1, 2002, Vol. 122-C, No. 7, pp. 1127-1136, published by The Institute of Electrical Engineers of Japan (Non-Patent Document 1). In the fingerprint verifying method in Non-Patent Document 1, a plurality of fingerprint templates is retained, and DP (dynamic programming) matching is conducted between the fingerprint information to be inputted and the fingerprint templates. When a minimum value of a DP distance obtained by a result of the DP matching is smaller than a predetermined threshold, the input fingerprint information is accepted, and when not, the input fingerprint information is rejected.

In the plurality of fingerprint templates, the fingerprint template whose DP distance is the largest is replaced with inputted fingerprint information, and the inputted fingerprint information is set as a new fingerprint template. Thus, the fingerprint template which seems to be the farthest from the current fingerprint state can be replaced with recently accepted fingerprint information. As a result, the operability of the fingerprint authentication system which is resistant to external disturbing factors such as finger dryness and finger moistness is expected to be improved.

In the fingerprint verifying method disclosed in Non-Patent Document 1, every time the verifying is carried out and input fingerprint information is accepted, the fingerprint template is replaced with it. For this reason, as to even a time-proven fingerprint template which is frequently used for authentication, when its DP distance with respect to an inputted fingerprint becomes larger than the other templates, this fingerprint template is subjected to replacement. For a similar reason, when the fingerprint authentication system accidentally accepts other person's input fingerprint information, the other person's fingerprint information is adopted as original user's fingerprint information into a fingerprint template. When there is a possibility that all the fingerprint templates are replaced by other people's fingerprint information, the original user cannot be authenticated. If such a situation arises, the operability and the reliability of the fingerprint authentication system noticeably deteriorate, and this is likely to hinder the spread of the system. Such a problem may arise not only in the biometric systems using fingerprints but also in biometric systems using another biologic information.

### SUMMARY

Some embodiments include a biometric apparatus which has a memory unit and a determining unit. The memory unit stores a registration biologic information template which is fixed and also stores at least one learning biologic information template which is subject to replacement. The determining unit is capable of operating in connection with the memory unit to receive an inputted biologic information, calculate a plurality of matching scores showing a respective degree of similarity between an inputted biologic information and each of a plurality of biologic information templates, determine whether the inputted biologic information is accepted based on the plurality of matching scores, and output a signal showing whether the inputted biologic information is accepted.

Some embodiments provide a method for biometric authentication, which includes obtaining a biologic information input which is to be accepted or rejected as being input from an authentic user; calculating a matching score which shows a degree of similarity between the biologic information input and a fixed registration biologic information template; for each of one or more non-fixed learning biologic information templates, calculating a matching score which shows a degree of similarity between the biologic information input and the learning biologic information template; determining whether the biologic information input is accepted as input from an authentic user based on the matching scores; and outputting a signal showing whether the biologic information input is accepted as input from an authentic user.

The examples given are merely illustrative. This Summary is not intended to identify key features or essential features of the claimed subject matter, nor is it intended to be used to limit the scope of the claimed subject matter. Rather, this Summary is provided to introduce—in a simplified form—some concepts that are further described below in the Detailed Description. The innovation is defined with claims, and to the extent this Summary conflicts with the claims, the claims should prevail.

### BRIEF DESCRIPTION OF THE DRAWINGS

A more particular description will be given with reference to the attached drawings. These drawings only illustrate selected aspects and thus do not fully determine coverage or scope.

FIG. 1 is a diagram illustrating a computer system which realizes a first embodiment;

FIG. 2 is a block diagram illustrating structures of the computer system shown in FIG. 1;

FIG. 3 is a block diagram illustrating a fingerprint authentication apparatus consistent with the first embodiment;

FIG. 4 is a flowchart illustrating a first half of a control structure of a program realizing a fingerprint information registering process in a computer program for realizing the fingerprint authentication apparatus consistent with the first embodiment;

FIG. 5 is a flowchart illustrating a last half of the control structure of the program for the fingerprint information registering process;

FIG. 6 is a flowchart illustrating a control structure of a program for realizing a fingerprint information verifying process in the fingerprint authentication apparatus consistent with the first embodiment;

FIG. 7 is a flowchart of a program for realizing a fingerprint information learning process of the fingerprint authentication apparatus consistent with the first embodiment;

FIG. 8 is a diagram schematically illustrating a fingerprint registering process consistent with the first embodiment;

FIG. 9 is a diagram schematically illustrating outlines of the fingerprint information verifying process and the fingerprint information learning process consistent with the first embodiment;

FIG. 10 is a flowchart illustrating a control structure of a program for realizing a fingerprint information verifying process in a fingerprint authentication apparatus consistent with a second embodiment; and

FIG. 11 is a flowchart illustrating a control structure of a program for realizing a fingerprint template learning process in the fingerprint authentication apparatus consistent with the second embodiment.

### DETAILED DESCRIPTION

Reference will now be made to exemplary embodiments such as those illustrated in the drawings, and specific language will be used herein to describe the same. But alterations and further modifications of the features illustrated herein, and additional applications of the principles illustrated herein, which would occur to one skilled in the relevant art (s) and having possession of this disclosure, should be considered within the scope of the claims.

The meaning of terms is clarified in this disclosure, so the claims should be read with careful attention to these clarifications. Specific examples are given, but those of skill in the relevant art(s) will understand that other examples may also fall within the meaning of the terms used, and within the scope of one or more claims. Terms do not necessarily have the same meaning here that they have in general usage, in the usage of a particular industry, or in a particular dictionary or set of dictionaries. Reference numerals may be used with various phrasings, to help show the breadth of a term. Omission of a reference numeral from a given piece of text does not necessarily mean the content of a Figure is not being discussed by the text.

The inventors assert and exercise their right to their own lexicography. Terms may be defined, either explicitly or implicitly, here in the Detailed Description and/or elsewhere in the application file.

For example, the terms “fingerprint”, “fingerprint template”, “fingerprint information”, and “fingerprint image” are used somewhat interchangeably herein, with deference to the ability of one of skill to determine from context whether reference is being made to the source of raw data, to raw data, or to a data structure derived by processing data, for example.

Also, the terms “first embodiment” and “second embodiment” are used for convenience to distinguish between a first group of embodiments and a second group of embodiments according to the absence or presence of certain process steps, as discussed below. However, the invention is not limited to those two embodiments. Indeed, it is not limited to precisely two embodiments under any of the criteria discussed. Embodiments can be grouped in other ways than by these process steps, e.g., according to the number of learning templates, according to the nature of the biometric data used (fingerprints, retinal scans, etc.), according to the extent to which they are implemented in hardware versus software, according to whether they adapt a general-purpose computer or instead use only special-purpose hardware, and so on.

Embodiments are described below. In the following description and drawings, like members are designated by like reference numerals and names, so that a detailed description is not necessarily repeated.

### Operating Environment

Embodiments in which fingerprints are used as an example of biometrics are among those described below. Biologic information to be used for biometrics is, however, not limited to fingerprints. For example, irises, palm vein patterns, voice patterns and the like can be used for biometrics in the same manner in some embodiments. In some embodiments, a fingerprint sensor is provided separately from computer hardware, and a function portion which processes fingerprint information acquired from the fingerprint sensor is realized by software which operates on the computer. But this is not required in every embodiment. For example, the fingerprint sensor which is provided separately from the computer hardware may incorporate a compact processor, and this processor may execute the program so as to cause the fingerprint sensor itself to operate as a fingerprint authentication apparatus. Similarly, hardware configured by a logic circuit realizing a function equivalent to the software can be mounted to the fingerprint sensor, so that the fingerprint sensor can be operated as the fingerprint authentication apparatus. The fingerprint sensor can be provided separately from a unit which processes fingerprint information, and both of them can be connected to a controlling device such as a computer.

### First Embodiment and Structures

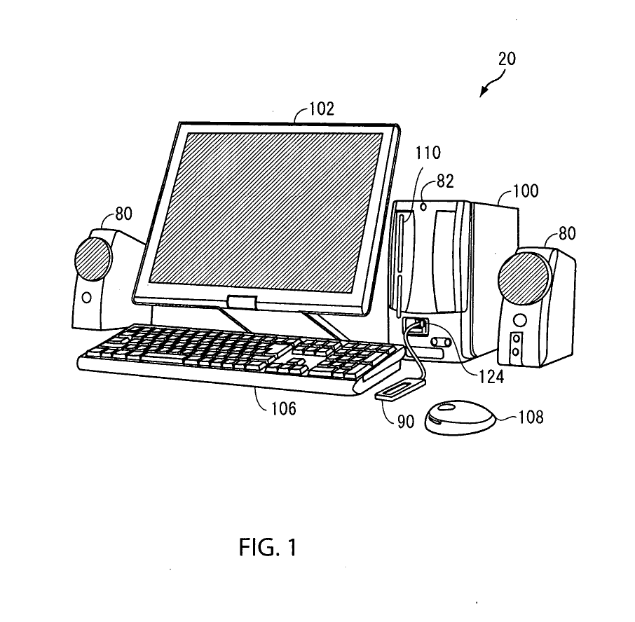

FIG. 1 illustrates an example of a computer system 20 which realizes a fingerprint authentication apparatus according to a first embodiment. With reference to FIG. 1, the computer system 20 includes a computer 100 having an I/O (Input/Output) port 124 and a DVD (Digital Versatile Disc) drive 110, a keyboard 106, a mouse 108, a monitor 102, a pair of speakers 80, a microphone 82 provided to the computer 100, and a fingerprint sensor 90 which inputs a fingerprint image into the fingerprint authentication apparatus. The fingerprint sensor 90 is connected to the computer 100 via the I/O port 124.

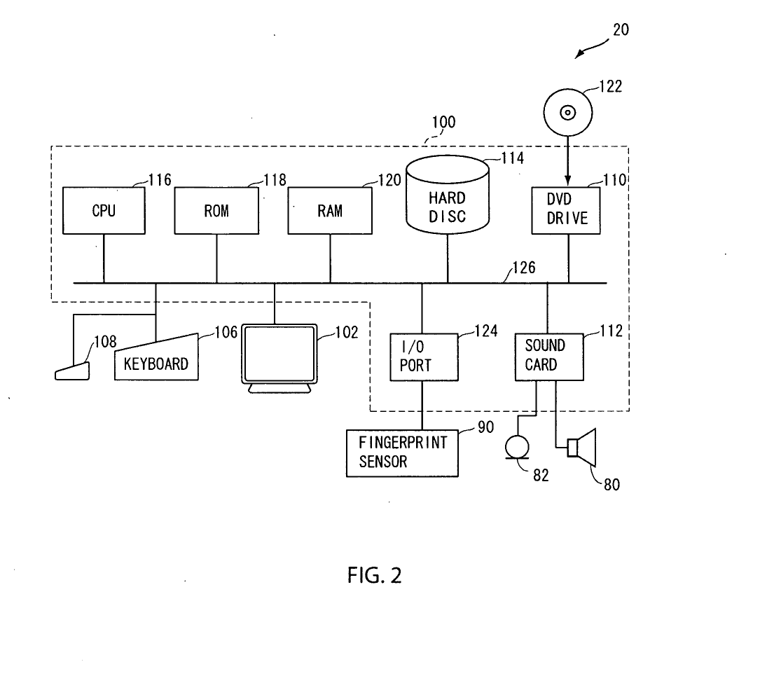

FIG. 2 is a block diagram illustrating structures of the computer 100 configuring the computer system 20. The structures may be implemented in hardware, hardware and firmware, and/or hardware and software, for example. With reference to FIG. 2, the computer 100 includes a CPU (Central Processing Unit) 116, and a bus 126 connected to the CPU 116.

The computer 100 further includes a ROM (Read Only Memory) 118, a RAM (Random Access Memory) 120, a hard disc 114, a DVD drive 110 into which a DVD 122 is inserted, an I/O port 124 connected to the fingerprint sensor 90, and a sound card 112 which is connected with the microphone 82 and the speakers 80. All of these components are connected to the bus 126. The ROM 118 is used for storing a program to be executed at the time of booting the computer 100. The RAM 120 is used as a work area of the CPU 116 and is also used as a storage place of the program when the CPU 116 executes it.

In the computer system 20, after the power is turned on and an OS (Operating System) is activated, a user authentication screen is displayed. The user inputs a fingerprint image by placing the user's finger on the fingerprint sensor 90, so that the user is authenticated by a fingerprint authentication program executed in the computer 100. When the user is authorized as a permitted user through the authentication, the user can use the computer 100 within the limitation of the authority set for the user. Otherwise, the display screen shows an error message, and then returns to the authentication screen.

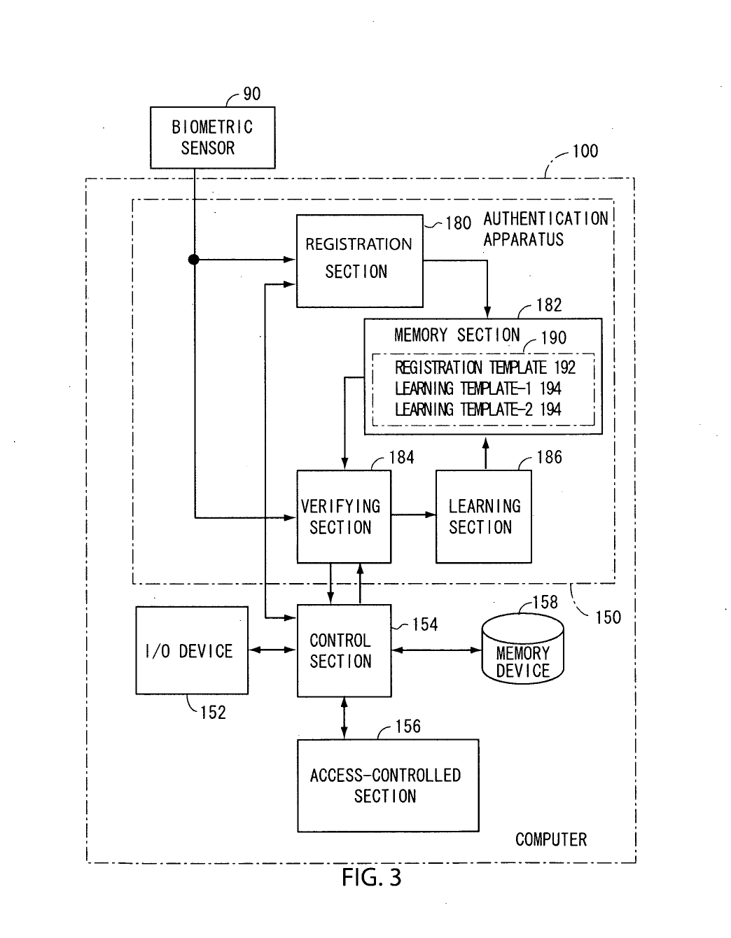

FIG. 3 is a block diagram illustrating a relationship between the fingerprint authentication apparatus 150 realized by the fingerprint authentication program to be executed on the computer 100 and the other portions of the computer 100. With reference to FIG. 3, the computer 100 includes the fingerprint authentication apparatus 150, a control section 154, an input/output device 152, a memory device 158, and a device section to be controlled 156.

The fingerprint authentication apparatus 150 receives a fingerprint image from the fingerprint sensor 90 and verifies the image with the plurality of fingerprint templates registered in advance, so as to authenticate a user. “Verify” is used with particular meaning as explained herein, and hence does not necessarily imply that access will be granted. “Verification” could be accurately paraphrased as “comparison” or as “testing”, for example.

The control section 154 is activated by turning on the power of the computer 100. The control section 154 starts up the fingerprint authentication apparatus 150, displays the authentication screen until the user is authenticated, and when the fingerprint authentication apparatus 150 completes the authentication, the control section 154 brings the computer 100 into an operating state so as to execute a process according to an authenticated user's instructions. The input/output device 152 is a device with which the user inputs information into the control section 154, and information is outputted to the user from the control section 154. The memory device 158 is used for storing data necessary for the process in the control section 154. The device section to be controlled 156 is controlled by the control section 154 and is configured by respective sections of the computer 100.

The input/output device 152 corresponds in some embodiments to one or more of the keyboard 106, the mouse 108, the monitor 102, the microphone 82, the speakers 80, the I/O port 124, the sound card 112, the DVD drive 110 and the like, shown in FIG. 2. The memory device 158 corresponds in some embodiments to one or more of the hard disc 114, the ROM 118, the RAM 120 and the like. The device section to be controlled 156 may correspond, for example, to all parts of the respective sections configuring the computer 100 other than the input/output device 152 and the memory device 158. In other embodiments only some parts of the system require authentication in order to be used, and the device section to be controlled is defined accordingly.

The fingerprint authentication apparatus 150 includes a fingerprint information memory section 182, a fingerprint information registration section 180, a fingerprint information verifying section 184, and a fingerprint information learning section 186. The fingerprint information memory section 182 stores a plurality (three in this embodiment) of fingerprint templates therein. The fingerprint information registration section 180 firstly installs the fingerprint authentication apparatus 150 in the computer 100, and executes a process for registering the fingerprint templates acquired from fingerprint information inputted from the fingerprint sensor 90 into the fingerprint information memory section 182. The fingerprint information verifying section 184 extracts feature information from the fingerprint information (fingerprint image) inputted from the fingerprint sensor 90 after the starting of the operation of the fingerprint authentication apparatus 150, verifies (compares) the extracted feature information with feature information of the fingerprint templates stored in the fingerprint information memory section 182 to attempt to authenticate a user so as to give the authenticated result to the control section 154. The fingerprint information learning section 186 obtains the result of verifying between the three fingerprint templates and the input fingerprint by means of the fingerprint information verifying section 184, executes the process for learning the fingerprint information (details are provided elsewhere herein), and executes a process for replacing some of the fingerprint templates stored in the fingerprint information memory section 182, for example.

As shown in FIG. 3, in the first embodiment, three fingerprint templates 190 are used. They are classified into one registration fingerprint template 192 which is not to be learned at the time of a learning operation, and two learning fingerprint templates 194 which are to be learned. The learning fingerprint templates include a first learning fingerprint template (hereinafter referred to as learning fingerprint template 1) and a second learning fingerprint template (hereinafter referred to as learning fingerprint template 2). The fingerprint information verifying section 184 verifies the three fingerprint templates with the input fingerprint information, and outputs matching scores. When the authentication succeeds, the fingerprint information learning section 186 replaces a learning fingerprint template having a lower score out of the learning fingerprint template 1 and the learning fingerprint template 2 with fingerprint information with which authentication succeeds, so as to update the learning fingerprint template.

The fingerprint authentication apparatus 150 shown in FIG. 3 is realized using computer programs in the first embodiment. In these programs, a program which realizes the fingerprint information registration section 180 is different from programs which realize the fingerprint information verifying section 184 and the fingerprint information learning section 186, in the first embodiment. The program which realizes the fingerprint information registration section 180 is stored in the DVD 122 or the like so as to be supplied to the computer 100 when the fingerprint sensor 90 is connected to the computer 100. This fingerprint information registration program can also be stored in the hard disc 114. This fingerprint information registration program is loaded on the RAM 120 so as to be executed by the CPU 116. When this fingerprint information registration program is executed, the fingerprint template acquired from a fingerprint image inputted from the fingerprint sensor 90 is stored in the fingerprint information memory section 182. The fingerprint information memory section 182 may be generally a part of a memory area which is present in the hard disc 114 shown in FIG. 2.

After the fingerprint templates are stored in the fingerprint information memory section 182, only the fingerprint information verifying section 184 and the fingerprint information learning section 186 are executed. The programs which execute the fingerprint information verifying section 184 and the fingerprint information learning section 186 are normally stored in the hard disc 114, and when the computer 100 is booted, these programs are loaded into the RAM 120 to be executed by the CPU 116. Every time a fingerprint is inputted through the fingerprint sensor 90, the fingerprint information verifying section 184 and the fingerprint information learning section 186 are operated to authenticate the fingerprint, and to update the fingerprint templates stored in the fingerprint information memory section 182 as described herein. The fingerprint sensor 90 may be connected via the input/output device 152.

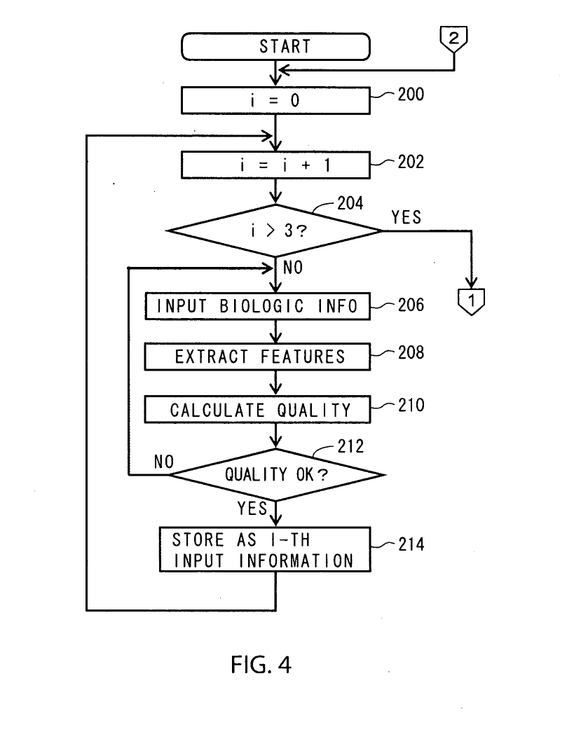

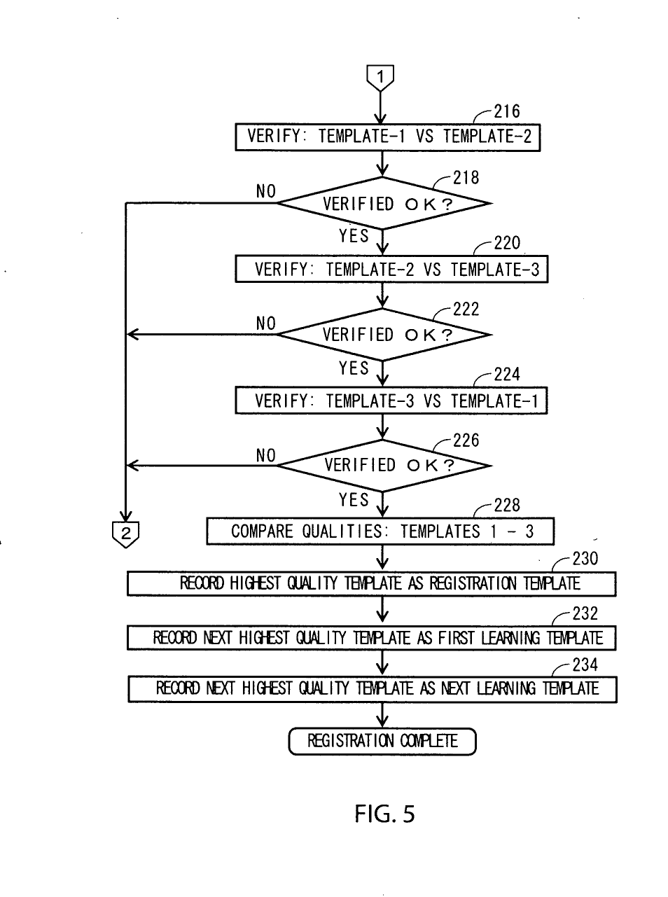

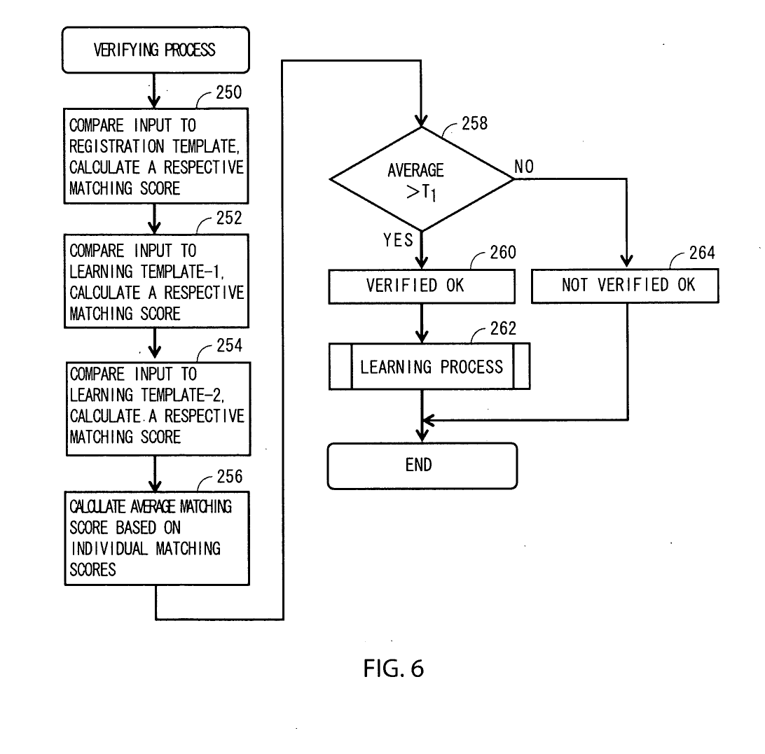

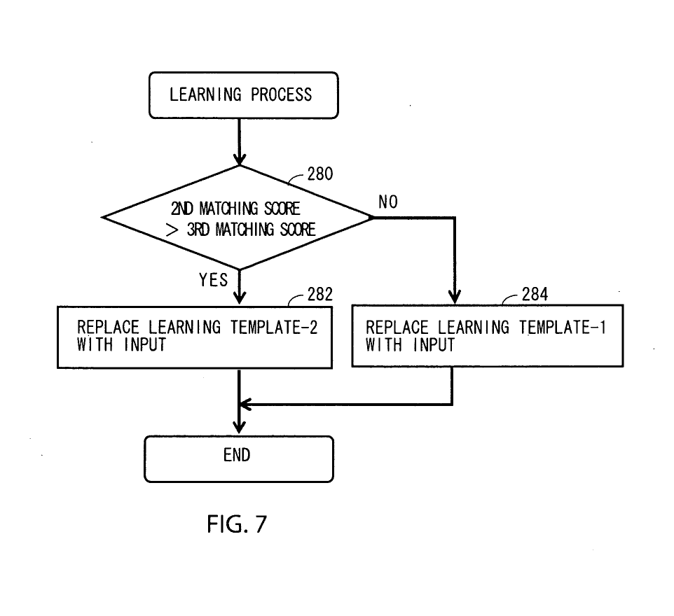

A control structure of the computer program realizing the fingerprint information registration section 180 is described below with reference to FIGS. 4 and 5. Control structures of the computer programs realizing the fingerprint information verifying section 184 and the fingerprint information learning section 186 are described with reference to FIGS. 6 and 7.

### Fingerprint Information Registration

FIGS. 4 and 5 respectively illustrate a first half and the last half of a flowchart illustrating the control structure of a template registration computer program realizing the fingerprint information registration section 180.

With reference to FIG. 4, the template registration program includes step 200 of assigning zero as an initial value to a variable expressing the number of the registered fingerprint templates, and step 202 of adding one to the variable i, and step 204 of determining whether the variable i is larger than 3 and branching control according to the determined result.

This template registration program further includes step 206, step 208, step 210 and step 212. At step 206 which is executed in response to the determination that the variable i is not more than 3 at step 204, a fingerprint image outputted from the fingerprint sensor 90 is inputted into the fingerprint authentication apparatus 150. At step 208, minutiae to be used for verifying the fingerprints are extracted from the inputted fingerprint image. At step 210, a quality score of the inputted fingerprint image is calculated; this may be based on the number of the obtained minutiae, for example. At step 212, a determination is made whether the quality score calculated at step 210 is larger than a predetermined threshold and the control is branched according to the determined result. When the determination is made that the quality score is not more than the threshold at step 212, the control returns to step 206.

There are various methods for calculating the quality score. For example, in one embodiment, a quality score function is determined based on an area of the acquired input fingerprint image portion and the number of feature points (minutiae) acquired from the image so that, as the area and the number of feature points become larger, the quality score becomes larger. By using this function, the quality score is calculated for an input fingerprint.

The template registration program shown in FIG. 4 further includes step 214 which is executed in response to the determination that the quality of the fingerprint image is larger than the predetermined threshold at step 212. At step 214, the input fingerprint image is stored as an i-th captured fingerprint in the RAM 120 shown in FIG. 2, and control is returned to step 202.

With reference to FIG. 5, the template registration program further includes step 216 which is executed in response to the determination that the variable i is larger than 3 at step 204 shown in FIG. 4, and step 218. At step 216, a first captured fingerprint is verified (compared) with a second captured fingerprint according to predetermined verifying algorithm for fingerprint verifying, and a score representing the verified result (a so-called “matching score”) is calculated. At step 218, a determination is made whether a verified result showing that both the fingerprints are identical is obtained depending on whether the matching score calculated at step 216 is larger than the predetermined threshold, and the control is branched according to the determined result. Various algorithms can be used for the verifying process; for example, a minutiae system can be used. Other algorithms can also be used for calculating the matching score; the DP matching used in the Non-Patent Document 1 is an example. The matching score is a criterion which indicates the level of similarity between the first taken fingerprint and the second taken fingerprint. At the actual verifying stage to be described later, the matching score indicates the level of similarity between the input fingerprint information and the fingerprint templates. In this example, as the score is higher, the possibility that both pieces of the fingerprint information are identical is higher.

The template registration program further includes step 220 which is executed in response to the determination that the verifying succeeds at step 218, step 222, step 224 which is executed in response to the determination that the verifying succeeds at step 222, and step 226. At step 220, the second captured fingerprint is verified with a third captured fingerprint in a similar manner as in step 216. At step 222, determination is made whether the verifying between the second captured fingerprint and the third captured fingerprint is successfully performed (namely, the comparison yields a determination of sufficient similarity between compared items), and the control is branched according to the determined result. At step 224, the third captured fingerprint is verified with the first captured fingerprint in a similar manner as in steps 216 and 220. At step 226, determination is made whether the verifying succeeds as a result of the verification executed at step 224, and control is branched according to the determined result.

When the determination is made that the compared items are not sufficiently similar and hence the verifying fails, at steps 218, 222 and 226, the control returns to step 200 shown in FIG. 4, so that the registering process starts over again.

Again with reference to FIG. 5, the template registration program further includes step 228 which is executed in response to the determination that the verifying between the third captured fingerprint and the first captured fingerprint succeeds at step 226, step 230, step 232 and step 234. At step 228, the quality of each of the first to third captured fingerprints is compared, and the fingerprints are sorted in the descending order of the quality. At step 230, the fingerprint having the highest quality obtained at step 228 is recorded as a “registration fingerprint template” into the fingerprint information memory section 182 shown in FIG. 3. At step 232, after step 230, information about the fingerprint determined as having the second highest quality at step 228 is recorded as the learning fingerprint template 1 in the fingerprint information memory section 182. At step 234, the fingerprint having the lowest quality is recorded as the leaning fingerprint template 2 into the fingerprint information memory section 182. After step 234, the process for registering fingerprint information is terminated.

### Fingerprint Information Verifying

FIG. 6 is a flowchart illustrating a control structure of a program realizing the fingerprint information verifying section 184 shown in FIG. 3. With reference to FIG. 6, the program which realizes the verifying process includes step 250, step 252, step 254 and step 256. At step 250, a fingerprint inputted from the fingerprint sensor 90 (hereinafter referred to as “input fingerprint”) is compared with the registration fingerprint templates stored in the fingerprint information memory section 182, and a first verifying score (matching score) is calculated to be temporarily recorded. At step 252, the input fingerprint is compared with the learning fingerprint template 1, and an obtained matching score is recorded as a second matching score. At step 254, the input fingerprint is compared with the learning fingerprint template 2, and an obtained matching score is recorded as a third matching score. At step 256, an average value of the first to third matching scores obtained in such a manner is calculated and recorded as an average matching score.

The fingerprint verifying (comparing) program further includes step 258, step 260, step 262, and step 264. At step 258, after step 256, determination is made whether the average matching score calculated at step 256 is larger than an empirically-predetermined threshold T₁, and the control is branched according to the determined result. At step 260 executed in response to the determination that the average matching score is larger than the threshold T₁ at step 258, information, which represents that the verifying succeeds and the use of the computer 100 by the user is authorized, is outputted to the control section 154 shown in FIG. 3. At step 262, after step 260, the learning process is executed, whereby one of the learning fingerprint template 1 and the learning fingerprint template 2 having a lower matching score (namely, less similarity) with respect to the input fingerprint is replaced with the input fingerprint, and the verifying process is terminated. At step 264 executed in response to the determination that the average matching score is not more than the threshold T₁ at step 258, information which represents that successful verifying is impossible (authentication failure), is given to the control section 154 shown in FIG. 3, so that the verifying process is terminated.

### Fingerprint Information Learning

With reference to FIG. 7, the learning process to be executed at step 262 shown in FIG. 6 includes step 280, step 282, and step 284. At step 280, determination is made whether the second matching score is larger than the third matching score. At step 282 executed in response to the determination that the second matching score is larger than the third matching score at step 280, the learning fingerprint template 2 is replaced with the input fingerprint, and the input fingerprint is stored as the learning fingerprint template 2 in the fingerprint information memory section 182 shown in FIG. 3. At step 284 executed in response to the determination that the second matching score is not more than the third matching score at step 280, the learning fingerprint template 1 is replaced with the input fingerprint, and the input fingerprint is stored as the learning fingerprint template 1 in the fingerprint information memory section 182 shown in FIG. 3. After steps 282 and 284, the learning process is terminated.

### Authentication Operation

The fingerprint authentication apparatus according to the first embodiment operates as follows. This apparatus has two operation phases, including a fingerprint information registering process and a verifying process. The verifying process is divided into a process for performing actual verifying, and a learning process for learning the learning fingerprint templates in the fingerprint information memory section according to the verified result. As for these three processes, the operation of the fingerprint authentication apparatus is described below.

### (1) Fingerprint Information Registering Process

In the first embodiment, when a fingerprint template is registered, three kinds of fingerprint information are registered. As is clear from steps 200 to 214 in FIG. 4, the three captured fingerprints which satisfy predetermined quality requirements are candidates for the fingerprint templates. Only the fingerprints which satisfy the predetermined quality requirements are used, in order to eliminate a situation in which fingerprint information unsuitable for verifying is wrongly registered, e.g., because a finger is not appropriately placed on the fingerprint sensor 90 or a finger is wounded. When the quality score reaches a certain threshold, the fingerprint information is registered, but when it does not reach the threshold, the fingerprint information is not registered and input of a fingerprint is again urged, e.g., by prompting the user on the monitor 102.

As is clear from steps 216 to 226 in FIG. 5, three kinds of captured fingerprint information are verified with each other, and only the fingerprint information with which verifying succeeds is registered in the form of templates. This is a process to help ensure that the templates to be registered are of one person's fingerprints, thereby preventing other persons' fingerprints from being wrongly registered.

As is clear from steps 228 to 234, the fingerprint having the highest quality score which is calculated at step 210 (see FIG. 4) is recorded as a registration fingerprint template, the fingerprint having the second highest quality score is recorded as the learning fingerprint template 1, and the fingerprint having the lowest quality score is recorded as the learning fingerprint template 2.

The number of pieces of fingerprint information to be registered as the fingerprint templates is not necessarily three, and in some embodiments the number can be changed according to circumstances such as a required security level.

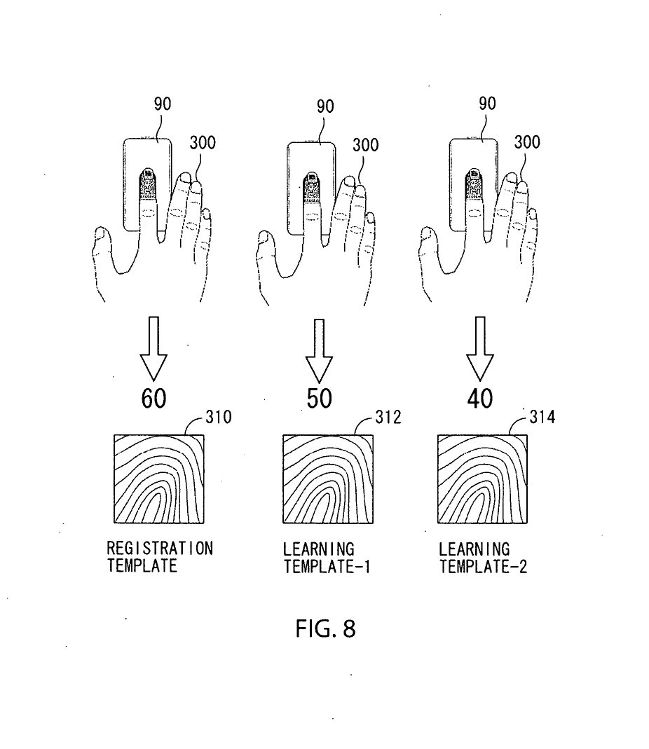

FIG. 8 schematically illustrates a specific registering state. With reference to FIG. 8, the fingerprint sensor 90 is used to capture images 310, 312 and 314 of an index finger of a user's hand 300. The qualities of the fingerprint information acquired from these images are estimated to be 60, 50 and 40 as the values of the quality scores. In this case, the fingerprint information acquired from the fingerprint having a quality score of 60 is registered as the registration fingerprint template, the fingerprint information acquired from the fingerprint having a quality score of 50 is registered as the learning fingerprint template 1, and the fingerprint information acquired from the fingerprint having a quality score of 40 is registered as the learning fingerprint template 2.

### (2) Verifying Process

In the first embodiment, at the time of the fingerprint verifying, an input fingerprint is compared with a number of registered fingerprint templates. At steps 250 to 254 shown in FIG. 6, the input fingerprint is verified (compared) with the registration fingerprint template, the learning fingerprint template 1 and the learning fingerprint template 2, thereby obtaining three matching scores which are retained as the first to third matching scores. Similar to the verifying process in the fingerprint information registering process, any suitable verifying algorithm can be adopted. At step 256 in FIG. 6, an average value of these scores is calculated and is recorded as an average matching score.

The matching score is a measure which shows how much the input fingerprint information is similar to the fingerprint templates, namely, the degree of similarity. In some embodiments, as the matching score is higher, the possibility that both pieces of fingerprint information are identical is higher.

At step 258 in FIG. 6, determination is made whether the calculated average matching score is larger than a predetermined threshold T₁. When the average matching score is larger than the threshold T₁, information which indicates that the verifying succeeds at step 260 is outputted to the control section 154 shown in FIG. 3. In response to the information, the control section 154 enables the operation of the device section to be controlled 156. Thereafter, at step 262, the learning process is executed as follows.

### (3) Learning Process

With reference to FIG. 7, in the learning process, when the second matching score calculated for the learning fingerprint template 1 is larger than the third matching score calculated for the learning fingerprint template 2, the sequence goes to step 282, otherwise, the sequence goes to step 284, so that the respective processes are executed.

At step 282, the learning fingerprint template 2 is replaced with the input fingerprint, and the process is terminated. That is to say, the learning fingerprint template 2 corresponding to the matching score showing the lowest degree of similarity is replaced with the fingerprint information acquired from the input fingerprint, and the fingerprint information is stored as anew learning fingerprint template 2 in the fingerprint information memory section 182 (see FIG. 3). On the other hand, at step 284, the learning fingerprint template 1 is replaced with the input fingerprint, and the process is terminated. That is to say, the learning fingerprint template 1 corresponding to the matching score showing the lowest degree of similarity is replaced with the fingerprint information acquired from the input fingerprint, and the fingerprint information is stored as anew learning fingerprint template 1 in the fingerprint information memory section 182.

Again with reference to FIG. 6, when the determination is made at step 258 that the average matching score is not more than the threshold T₁, information showing that successful verifying did not occur (an authentication failure) is given to the control section 154 at step 264. When this information is given to the control section 154, the operation of the device section to be controlled 156 is disabled, and an authentication screen is displayed without change until an authentication success is notified from the fingerprint authentication apparatus 150.

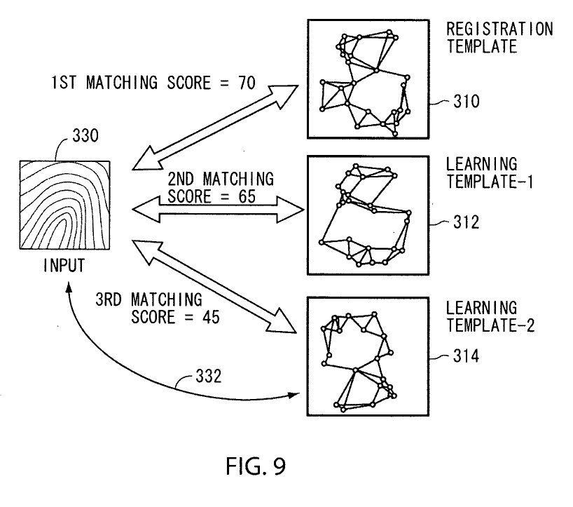

The results of the verifying process and the learning process are described with reference to FIG. 9 by showing specific examples. In FIG. 9, as results of verification of an input fingerprint 330 with a registration fingerprint template 310, the leaning fingerprint template 1 (312) and the learning fingerprint template 2 (314), the first matching score, the second matching score and the third matching score are assumed to be 70, 65 and 45 respectively. In this case, the average matching score is 60. When the threshold T₁ to be used at step 258 is set to be 55, the learning fingerprint template 2 (314) whose matching score is lower than that of the learning fingerprint template 1 (312) is replaced with fingerprint information acquired from the input fingerprint 330 as shown by an arrow 332.

The threshold T₁ to be used at step 258 in FIG. 6 may be set by any suitable means. In particular, this value can be determined by empirical or statistical means based on a number of experiments. That is to say, the threshold T₁ may be set so that a probability that other people's fingerprint information is accidentally determined as “verifying OK” is not more than a predetermined criterion. The threshold T₁ can be adjusted to a value according to circumstances such as a required security level.

As is clear from the above description, in the first embodiment, the registration fingerprint template is never replaced by an inputted fingerprint even when authentication succeeds. On the other hand, one of the learning fingerprint template 1 and the learning fingerprint template 2 showing lower degree of similarity with respect to the input fingerprint is replaced.

In the first embodiment, the plurality of fingerprint templates and an input fingerprint are verified in the verifying process, and the obtained plurality of matching scores are used for the authentication. For this reason, the risk of replacing the fingerprint template with another person's fingerprint information accidentally accepted can be reduced. Since the average matching score as an average of the plurality of matching scores is compared with the threshold T₁ to conduct the authentication, even when the matching score acquired from one of the templates happens to be smaller or larger the other ones, an influence caused by such situation on the verified results is reduced, so that more stable authentication can be made.

In the first embodiment, in the learning process, the registration fingerprint template included in the three fingerprint templates is exempted from the replacement. Therefore, even if another person's input fingerprint information is accidentally accepted, not all of the fingerprint templates are replaced with that other person's fingerprint information. Even if another person's fingerprint information is registered as the learning fingerprint template, this learning fingerprint template can be replaced with a template obtained from proper fingerprint information at the time of next verifying. In some embodiments of the learning process, although the registration fingerprint template is not replaced, the fingerprint information which is close to a latest fingerprint state is always registered as the learning fingerprint template. For this reason, the verifying process can be executed flexibly and safely regardless of a change in the fingerprint state caused by external factors such as climate and seasonal change.

In this example of the first embodiment, there exists one registration fingerprint template and two learning fingerprint templates. However, the present invention is not limited to such an embodiment. The number of the registration fingerprint templates may be two or more, and the number of the learning fingerprint templates may be one or more.

### Second Embodiment

The fingerprint authentication apparatus according to a second embodiment described below is similar in many ways to the first embodiment. However, as is described below, in the second embodiment programs for the verifying process and the learning process are more or less modified.

### Verifying Process

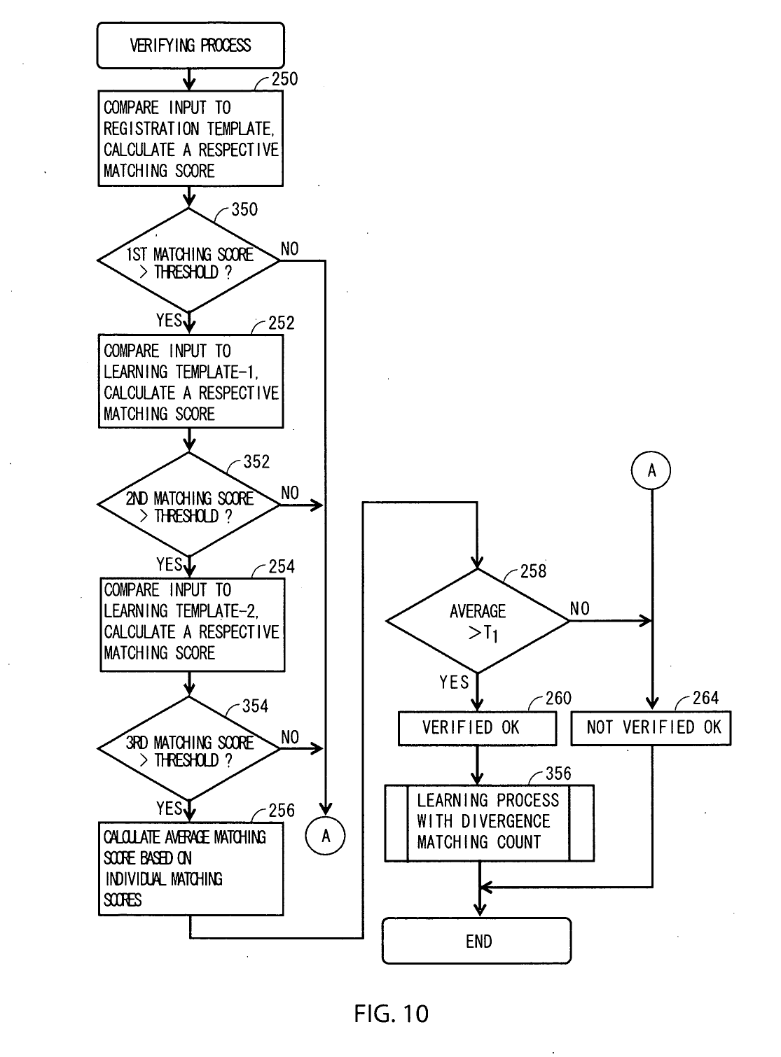

With reference to FIG. 10, the verifying process in the second embodiment includes step 350 which is inserted between steps 250 and 252 in the program of the verifying process shown in FIG. 6, step 352 which is inserted between steps 252 and 254 shown in FIG. 6, and step 354 which is inserted between steps 254 and 256 shown in FIG. 6. At step 350, determination is made whether the first matching score obtained at step 250 is larger than the predetermined threshold Tx. When the score is larger than the threshold, the control goes to step 252, and in the other cases, the control goes to step 264. At step 352, determination is made whether the second matching score obtained at step 252 is larger than the threshold Ty. When the score is larger than the threshold, the control goes to step 254, and in the other cases, the control goes to step 264. At step 354, determination is made whether the third matching score obtained at step 254 is larger than the threshold Tz. When the score is larger than the threshold, the control goes to step 256, otherwise, the control goes to step 264.

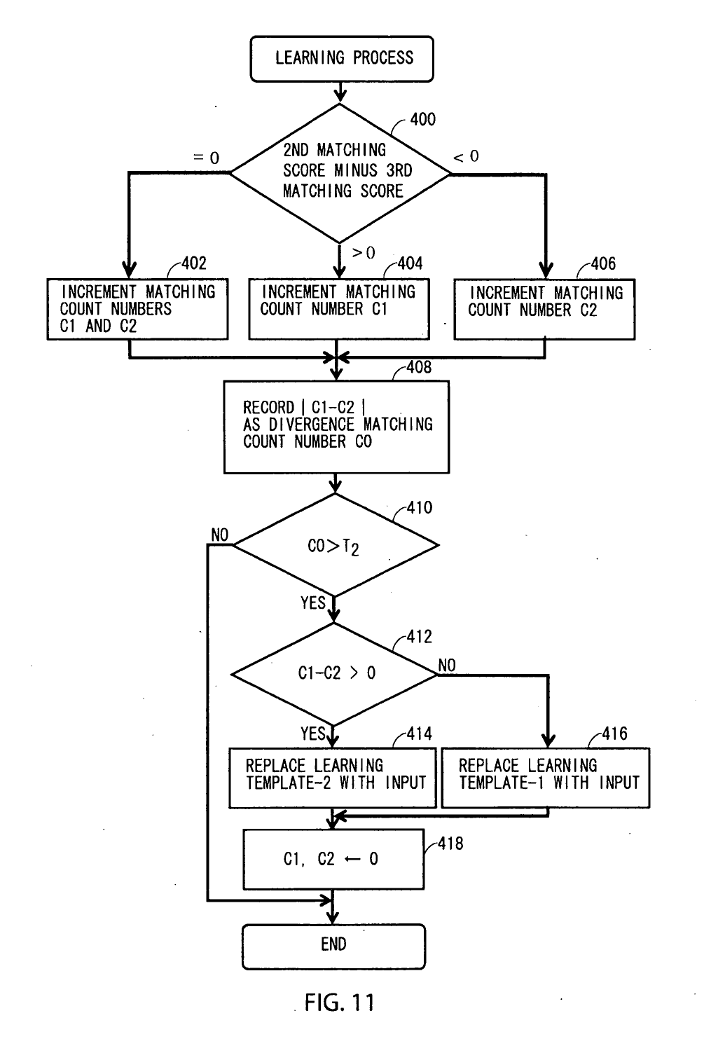

Instead of step 262 shown in FIG. 6, this FIG. 10 verifying process includes step 356 wherein a learning process using a divergence matching count number C0 is executed. The learning process to be executed at step 356 is described later with reference to FIG. 11.

In an execution of a verifying program shown in FIG. 10, if at least one of the three matching scores which are calculated between the input fingerprint and the registration fingerprint template, the learning fingerprint template 1 and the learning fingerprint template 2 are less than the predetermined threshold respectively, then the determined result is verifying failure. When all the three matching scores are larger than the respective thresholds and the average matching score is larger than the threshold T₁ for the average matching score, then the verifying succeeds. Therefore, the respective matching scores should exceed the respective thresholds at the time of the verifying. The thresholds Tx, Ty and Tz are referred to as “lowest matching scores” hereinafter. In the second embodiment, it is assumed that the lowest matching score Tx, Ty, Tz are different from each other.

### Learning Process

FIG. 11 is a flow chart illustrating a program realizing the learning process (the process to be executed at step 356 in FIG. 10) according to the second embodiment. In the second embodiment in this example, similarly to the first embodiment example discussed above, one registration fingerprint template and two learning fingerprint templates are used. In the first embodiment, every time when the verifying succeeds, the learning fingerprint template having the lowest matching score is replaced with fingerprint information obtained from an input fingerprint. On the other hand, in the second embodiment, the learning fingerprint template is not replaced every time when the verifying succeeds. Instead, the process for comparing the matching scores of the two learning fingerprint templates is repeated for each verifying process. When the number of times at which the matching score of any certain learning fingerprint template exceeds that of the other learning fingerprint template and reaches a predetermined threshold, the other learning fingerprint template is replaced with the fingerprint information obtained from the input fingerprint.

In order to execute such a learning process, first and second matching count numbers C1 and C2 as attributes are added to the learning fingerprint template 1 and the learning fingerprint template 2, respectively. An absolute value |C1−C2| of a difference between the first and second matching count numbers C1 and C2 is computed and called “a divergence matching count number” as a value showing a degree of divergence between C1 and C2, and is denoted by C0.

With reference to FIG. 11, this learning program includes step 400, step 402, step 404, step 406 and step 408. At step 400, a third matching score calculated for the learning fingerprint template 2 is subtracted from a second matching score calculated for the learning fingerprint template 1, and then the control is branched into one of three paths according to results of the subtracted difference which are zero, a positive value and a negative value. At step 402, which is executed in response to the determination that the difference is equal to zero at step 400, the first and second matching count numbers C1 and C2 are incremented by one. At step 404, which is executed in response to the determination that the difference is a positive value at step 400, the first matching count number C1 is incremented by one. At step 406, which is executed in response to the determination that the difference is a negative value at step 400, the second matching count number C2 is incremented by one. At step 408, which is executed after steps 402, 404 and 406, the absolute value |C1−C2| is recorded as the divergence matching count number C0.

The values by which the first and second matching count numbers C1 and C2 are incremented are not always one at one-time verifying. It may be variable, taking the matching scores or the like into consideration. For example, when the second matching score and the third matching score as the matching scores corresponding to the learning fingerprint template 1 and the learning fingerprint template 2 are 65 and 30, respectively, the matching count number C1 is incremented by one normally, but may be incremented by two. This is because it is supposed that the second matching score is two or more times larger than the third matching score, which clearly shows that the reliability of the learning fingerprint template 1 is high and that of the learning fingerprint template 2 is low. That is to say, the reliabilities of the learning fingerprint templates can be estimated from the obtained matching scores, and based on this estimation the increment value may be variable. In this case, the matching count numbers C1 and C2 indicate not only the number of verifying times but the matching count number (data about the number of selection times) where the reliability is also taken into account.

This learning program further includes step 410 and step 412. At step 410, which is executed after step 408, determination is made whether the divergence matching count number C0 is larger than a predetermined threshold T₂, and the control is branched according to the determined result. At step 412, which is executed in response to the determination that the divergence matching count number C0 is larger than the threshold T₂ at step 410, determination is made whether the first matching count number C1 minus the second matching count number C2 is a positive value, and the control is branched according to the determined result.

The learning program further includes step 414, step 416 and step 418. At step 414, which is executed in response to the determination that C1−C2 is a positive value at step 412, similarly to step 282 in FIG. 7, the learning fingerprint template 2 is replaced with fingerprint information obtained from an input fingerprint. At step 416, which is executed in response to the determination that the difference C1−C2 is not more than zero at step 412, as at step 284 shown in FIG. 7, the learning fingerprint template 1 is replaced with the fingerprint information obtained from the input fingerprint. At step 418, which is executed after steps 414 and 416, zero is assigned as an initial value to the first and second matching count numbers C1 and C2.

When the determination is made at step 410 that the divergence matching count number C0 is not more than the threshold T₂, and when the process at step 418 is ended, this learning process is terminated.

In the second embodiment example, when a predetermined condition is satisfied, the learning fingerprint template is replaced based on the matching count numbers. That is to say, every time the verifying succeeds, the matching score of the input fingerprint is compared with that of the learning fingerprint template 1 and 2 respectively. Then one is added to the matching count number corresponding to the learning fingerprint template having a larger matching score. When two or more matching scores have same value, one is added to each of the corresponding count numbers. Next, the divergence matching count number as a difference of the matching count numbers is calculated, and when its value is larger than the predetermined threshold T₂, the learning fingerprint template having a smaller matching count number is replaced with the fingerprint information acquired from the input fingerprint. After that, zero as the initial value is assigned to both the matching count numbers C1 and C2. When the divergence matching count number is not more than T₂, this learning process is terminated.

Therefore, when the matching score of the learning fingerprint template 1 is near to that of the learning fingerprint template 2, namely, the matching count numbers are sufficiently close to each other, these learning fingerprint templates are not replaced with fingerprint information obtained from an input fingerprint and are used for a long period. That the divergence matching count number becomes large means that the matching score of one learning fingerprint template keeps on being smaller than the other one for a relatively long period. For this reason, it is considered that such learning fingerprint template is greatly different from the inputted fingerprint information. In such a case, the learning fingerprint template is replaced with the fingerprint information acquired from the input fingerprint.

Therefore, the learning fingerprint template having high reliability is used for a long period, and the learning fingerprint template having low reliability is replaced after a relatively short period.

It is expected that this second embodiment will behave differently in some cases than the first embodiment. In the first embodiment, the average matching score of three matching scores is used so that determination is made whether verifying succeeds or fails. However, when the matching scores are largely unbalanced, there is a risk that another person's fingerprint is accepted, as described below. For example, when the scores are largely unbalanced such that the first matching score is 90, the second matching score is 70 and the third matching score is 5, the average matching score is 55. In this case, when the threshold T₁ is not more than 54, an inputted fingerprint is accepted. Furthermore, the third matching score is as low as 5, which implies that the inputted fingerprint is another person's fingerprint. Nonetheless, this fingerprint might be accepted.

By contrast, in the second embodiment, a lowest matching score as a minimum matching score to be exceeded is used for each of the fingerprint templates. When all the matching scores obtained for the fingerprint templates are larger than the lowest matching scores, the verifying process is executed by using the average score, otherwise, the inputted fingerprint is not accepted. Therefore, a risk of accepting another person's fingerprint accidentally can be reduced. In the second embodiment, in the learning process, the learning fingerprint template whose matching score calculated with respect to an inputted fingerprint is frequently lower than that of the other fingerprint template, is replaced with the fingerprint information obtained from the input fingerprint by using the divergence matching count number. The learning fingerprint template which is greatly different from the latest finger state is replaced with new one relatively quickly, so that the retained learning fingerprint templates can be kept close to the latest finger state. As a result, an influence of an external factor on the finger state can be reduced, so that the verifying can be provided with high reliability.

The case where both the learning fingerprint template 1 and the learning fingerprint template 2 have comparable matching count numbers, namely, the case where the both the matching count numbers are close, is considered. In such a case, it is considered that both the learning fingerprint templates have a certain level of matching score number. In this case, there is a risk of degrading the learning fingerprint template reliability, when a replacement process is executed as described in the first embodiment, where the learning fingerprint template is replaced at each instance of the verifying process. In the first embodiment, that learning fingerprint template could be again eliminated at the next verifying, but such a risk may be reduced by the second embodiment.

In the second embodiment, such a risk can be reduced by the use of the divergence matching count number. That the divergence matching count number is large means that either one of the learning fingerprint templates is relatively quite different from the input fingerprint. Such a fingerprint template is replaced with the inputted fingerprint having the latest fingerprint state, so that the learning fingerprint template is successively updated to reflect the latest finger template state. As a result, at the time of the verifying of the input fingerprint, the influence of external factors such as skin dryness and skin moistness on the reliability of the authentication can be reduced.

The threshold T₂ to be compared with the divergence matching count number may be determined by empirical and/or statistical means based on a number of experiments or the like.

In the second embodiment, since the number of the learning fingerprint templates is only two, the above process is executed. It can also be said that the second embodiment uses a process for determining which learning fingerprint template frequently exhibits lower matching score and replacing the worse learning fingerprint templates with latest fingerprint information. According to this, a similar effect can be expected by adding one to the matching count number for the learning fingerprint with lower matching score, instead of adding one to matching count number for the learning fingerprint with larger matching score.

Now, in the case where the number of learning fingerprint templates is more than two, for example, a learning fingerprint template having the lowest matching score with respect to inputted fingerprint information is selected, and at every selection, one is added the matching count number therefor. Then, when a matching count number among every learning fingerprint template exceeds a predetermined value, the learning fingerprint template corresponding to that matching count number is replaced with the latest fingerprint information. Through such a process, the learning fingerprint template which differs from the latest fingerprint information more than the other learning fingerprint template(s) is replaced with the latest fingerprint information, thereby the current user's fingerprint state can be reflected to the learning fingerprint template.

Alternatively, the learning fingerprint template having the largest matching score with respect to inputted fingerprint information is selected, and at every such selection, one is added to the matching count number for that learning fingerprint template. When a smallest matching count number becomes less than any other matching count numbers, the learning fingerprint template corresponding to the smallest matching count number is replaced with the latest fingerprint information. Through such a process, the learning fingerprint template which differs from the latest fingerprint information more than the other learning fingerprint template(s) is replaced with the latest fingerprint information, thereby the current user's fingerprint state can be reflected to the learning fingerprint template.

### ADDITIONAL EXAMPLES

Some embodiments provide a biometric apparatus including a memory unit storing a registration biologic information template 192 which is fixed and at least one learning biologic information template 194 which is subject to replacement; and a determining unit capable of operating in connection with the memory unit to: receive an inputted biologic information, calculate a plurality of matching scores showing a respective degree of similarity between an inputted biologic information and each of a plurality of biologic information templates,

determine whether the inputted biologic information is accepted based on the plurality of matching scores, and output a signal showing whether the inputted biologic information is accepted.

The memory unit may include, for example, hard disc 114 and/or RAM 120. The determining unit may include, for example, CPU 116 configured with data and instructions from DVD drive 110 and medium 122, for example, for performing the indicated calculating, determining, and outputting steps. The determining unit may include a fingerprint or other biometric sensor 90 and an I/O port 124 to receive an inputted biologic information.

In some embodiments, the memory unit stores a plurality of learning biologic information templates 194, and the determining unit calculates matching scores for each of a plurality of learning biologic information templates.

Some embodiments further include a template learning unit capable of operating in connection with the memory unit and the determining unit to replace a learning biologic information template 194 stored in the memory unit with the inputted biologic information in response to a determination of acceptance of the inputted biologic information by the determining unit. For example, the template learning unit may include control section 154 and fingerprint information learning section 186 or a similar learning section for other biologic information.

In some embodiments, the template learning unit operates to replace the learning biologic information template 194 which has a matching score indicating a least degree of similarity between the learning biologic information template and the inputted biologic information.

In some embodiments, the determining unit is further capable of operating in connection with the memory unit to calculate an average score as an average value of the matching scores, e.g., as in step 256, and to determine whether the inputted biologic information is accepted based on whether the average score indicates at least a predetermined average degree of similarity. This may be done, for example, in a manner consistent with FIG. 6.

In some embodiments, the determining unit is further capable of operating in connection with the memory unit to calculate an average score as an average value of the matching scores and to determine whether the inputted biologic information is accepted based firstly on whether the average score indicates at least a predetermined average degree of similarity, and based secondly on whether each of the matching scores indicates at least a respective predetermined individual degree of similarity. This may be done, for example, in a manner consistent with FIG. 10.

Some embodiments further include a template registration unit which registers the registration biologic information template 192 and the at least one learning biologic information template 194 in the memory unit, such that the registration biologic information template cannot be replaced during normal operation of the apparatus and the at least one learning biologic information template can be replaced during normal operation of the apparatus. For example, the template registration unit may include control section 154 and fingerprint information registration section 180 or a similar registration section for other biologic information. As used herein, normal operation (which drives commercial activity) excludes technically sophisticated manipulation of the device, which may occur for example during diagnostic operation or during the testing of an apparatus whose functionality has been modified, e.g., by use of revised software and/or different circuitry.

In some embodiments, the determining unit is further capable of operating in connection with the memory unit to select a learning biologic information template whose matching score is an extreme (largest or smallest) after the inputted biologic information is accepted by the determining unit, and to accumulate data based on the number of times a given learning biologic information template is selected.

Some embodiments provide a method for biometric authentication, including the steps of: obtaining a biologic information input which is to be accepted or rejected as being input from an authentic user; calculating a matching score which shows a degree of similarity between the biologic information input and a fixed registration biologic information template; for each of one or more non-fixed learning biologic information templates, calculating a matching score which shows a degree of similarity between the biologic information input and the learning biologic information template; determining whether the biologic information input is accepted as input from an authentic user based on the matching scores; and outputting a signal showing whether the biologic information input is accepted as input from an authentic user. These steps may be accomplished as discussed above, for example, in connection with FIGS. 4 through 11.

Some embodiments further include the step of replacing a learning biologic information template, such as a fingerprint learning template, with a biologic information input which has been accepted as input from an authentic user, e.g., in a manner consistent with FIG. 7. In some embodiments, the replacing step replaces the learning biologic information template which has a matching score indicating the least degree of similarity with the biologic information input.

In some embodiments, the method further includes calculating an average matching score as an average value of the matching scores, e.g., as in step 256, and the determining step determines whether the biologic information input is accepted as input from an authentic user based on whether the average matching score indicates at least a predetermined average degree of similarity.

In some embodiments, the method further includes calculating an average matching score as an average value of the matching scores, and the determining step determines whether the biologic information input is accepted as input from an authentic user based on whether two conditions hold, namely, the average matching score indicates at least a predetermined average degree of similarity, and each of the matching scores indicates at least a respective predetermined individual degree of similarity, e.g., as in FIG. 11.

In some embodiments, the method further includes the steps of: selecting a learning biologic information template based on its matching score; incrementing a selection-times counter associated with the selected learning biologic information template; replacing a learning biologic information template whose selection-times counter satisfies a predetermined condition; and initializing the selection-times counter of the replaced learning biologic information template. As used herein, “incrementing” includes adding or subtracting by one or by some other predetermined value, or by a value calculated dynamically as discussed in the example involving matching scores that are two or more times larger than other matching scores. Matching count numbers C1 and C2 discussed above in connection with FIG. 11 are examples of selection-times counters.

In some embodiments, the method further includes the steps of: selecting a learning biologic information template whose matching score, of all the current matching scores, indicates the least degree of similarity with biologic information input; incrementing a selection-times counter associated with the selected learning biologic information template; and replacing a learning biologic information template whose selection-times counter satisfies a predetermined condition. In some embodiments, the selection-times counter satisfies at least one of the following predetermined conditions: (a) the selection-times counter is larger than a predetermined standard value, (b) the selection-times counter has the largest value of the current selection-times counters, (c) the selection-times counter has the largest value of the current selection-times counters and also the absolute value of the difference between the largest selection-times counter and the next largest selection-times counter is larger than a predetermined value.

In some embodiments, the method further includes the steps of: selecting a learning biologic information template whose matching score, of all the current matching scores, indicates the greatest degree of similarity with biologic information input; incrementing a selection-times counter associated with the selected learning biologic information template; and replacing a learning biologic information template whose selection-times counter satisfies a predetermined condition. In some embodiments, the selection-times counter satisfies at least one of the following predetermined conditions: (a) the selection-times counter is smaller than a predetermined standard value, (b) the selection-times counter has the smallest value of the current selection-times counters, (c) the selection-times counter has the smallest value of the current selection-times counters and also the absolute value of the difference between the smallest selection-times counter and the next smallest selection-times counter is larger than a predetermined value.

It is an object of some embodiments to provide a biometric apparatus and a biometric program capable of authenticating an authentic person with high reliability in response to a change in biologic information due to external conditions and of improving its operability.

A biometric apparatus according to a first aspect of the present invention includes a memory unit and a determining unit. The memory unit stores a plurality of biologic information templates 190 for biometrics. The determining unit accepts biologic information for biometrics, calculates a plurality of matching scores showing degree of similarity with respect to the plurality of biologic information templates, e.g., using section 184, and determines whether the biologic information is accepted based on the plurality of matching scores to output a signal showing a determined result. The plurality of biologic information templates includes a registration biologic information template 192 which is recorded in a fixed manner, and learning biologic information templates 194 which are to be replaced at the time of operating the biometric apparatus. The biometric apparatus further includes a template learning unit, e.g., section 186 which replaces one of the learning biologic information templates stored in the memory unit with the biologic information in response to the determination of the acceptance of the biologic information by the determining unit.

The memory unit stores the registration biologic information template and the learning biologic information templates in advance. When biologic information is given, the determining unit verifies (compares) the registration biologic information template and the learning biologic information templates with the given biologic information, and calculates matching scores representing the degree of similarity therebetween. The determining unit determines whether the given biologic information should be accepted based on the matching scores to output a signal showing the determined result. Since the verifying (comparing) is carried out by using the plurality of templates, the reliability of the checked result becomes higher than that in the case where single template is used. On the other hand, when the determining unit determines that the biologic information is accepted, the template learning unit replaces the learning biologic information template with the biologic information. Since the learning biologic information templates are updated in such a manner, the latest biologic information is always reflected to some of the learning biologic information templates. For this reason, even when a biologic state changes due to a change in an external condition such as a seasonal condition, the biologic information which should be accepted is can be prevented from being rejected erroneously. Among the biologic information templates, the registration biologic information template is not replaced with new biologic information. For this reason, even when biologic information which should be rejected is accepted accidentally, the biologic information templates are not completely replaced with other person's biologic information, and thus its influence is limited. As a result, it is possible to provide a biometric apparatus which can authenticate an identical person with high reliability according to a change in biologic information due to an external condition and can improve its operability.

In some embodiments, the memory unit stores a plurality of learning biologic information templates, and the template learning unit includes a template replacing unit which replaces the learning biologic information template corresponding to the matching score representing the least degree of similarity among the matching scores calculated for the plurality of learning biologic information templates with biologic information in response to the determination that the biologic information is accepted by the determining unit, to store the biologic information as a new learning biologic information template in the memory unit.

A plurality of learning biologic information templates are stored in the memory unit. Among the learning biologic information templates, the biologic information template showing the least degree of similarity with respect to accepted biologic information according to the matching scores calculated between the accepted biologic information and the learning biologic information templates is replaced with the accepted biologic information. Since the learning biologic information template which is most different from the newly inputted and accepted biologic information is replaced, all the learning biologic information templates are kept in a form which reflects the latest biologic state. Only the learning biologic information template having the least degree of similarity is replaced, and the registration biologic information template is not replaced. For this reason, the influence of any particular instance of biologic information on what will be accepted for authentication is limited, and all the biologic information templates are no longer in danger of being replaced with accidentally accepted biologic information. As a result, it is possible to provide a biologic information authentication apparatus which can perform authentication using biologic information with high reliability.

In some embodiments, the determining unit includes a matching score calculating unit, an average score calculating unit and a determining unit. The matching score calculating unit calculates matching scores showing the degree of similarity between the registration biologic information template and the learning biologic information template and biologic information. The average score calculating unit calculates an average score as an average value of the matching scores calculated by the matching score calculating unit.

The determining unit determines whether biologic information is accepted based on whether the average score calculated by the average score calculating unit is not less than a predetermined first threshold.

The determining unit determines whether the biologic information is accepted based on the average value of the plurality of matching scores calculated with respect to the registration biologic information template and the learning biologic information template. Since the plurality of matching scores are used, even the biologic information having a low matching score with respect to a certain biologic information template is accepted as long as the matching score with respect to the other biologic information templates is sufficiently high. As a result, it is possible to provide a biologic information authentication apparatus, which reduces the influence of the state at the time of acquiring biological information is reduced, can perform authentication using biologic information stably and has high reliability.

The determining unit may include the following unit. When the average score calculated by the average score calculating unit is not less than the predetermined first threshold and the matching scores calculated by the matching score calculating unit are not less than a predetermined second threshold, this unit accepts biologic information, and when not, rejects the biologic information.

In the case where only the average score is used, when some matching scores are very low but the other matching scores are very high, the authentication succeeds. However, when some of the matching scores are very low, it may not be desirable that they are accepted. A second threshold as a lowest value is set for the matching score, and biologic information having a matching score which does not satisfy the second threshold is rejected, so that the acceptance can be eliminated. A risk of accepting other person's biologic information accidentally can thus be reduced.

The biometric apparatus further includes a template registration unit which stores the registration biologic information template and the learning biologic information templates in the memory unit. The template registration unit includes a quality score calculating unit, a selecting unit and a unit. The quality score calculating unit accepts a plurality of pieces of biologic information for biometrics, and calculates quality scores. The selecting unit selects the biologic information whose quality score calculated by the quality score calculating unit is not less than a predetermined value from the plurality of pieces of biologic information as the registration biologic information template in a descending order of the quality score, and selects the information as the learning biologic information template. The unit stores the biologic information selected by the selecting unit as the registration biologic information template in the memory unit in the descending order of the quality score calculated by the quality score calculating unit, and stores the other biologic information as the learning biologic information templates in the memory unit.

Since the registration biologic information and the learning biologic information having the quality not less than a predetermined quality are used, improper acceptance and improper rejection of biologic information at the time of operation can be reduced. Since particularly the registration biologic information is stored in a fixed manner and is not replaced with new one, the registration biologic information having the highest quality is used. The learning biologic information template could be replaced with biologic information acquired from new biologic information, but this template is limited to one which satisfies a predetermined quality, so that risks of accidentally accepting other person's biologic information and accidentally rejecting proper person's biologic information can be reduced.

When a biometric program according to a second aspect of the present invention is executed by a computer, the computer serves as a memory unit and a determining unit. The memory unit stores a plurality of biologic information templates for biometrics in a memory device. The determining unit accepts biologic information for biometrics, calculates a plurality of matching scores showing the degree of similarities with respect to the plurality of biologic information templates, and determines whether the biologic information is accepted based on the plurality of matching scores to output a signal showing the determined result. The plurality of biologic information templates include a registration biologic information template registered in a fixed manner, and learning biologic information templates to be replaced at the time of running the program. The program further causes the computer to function as a template learning unit which replaces one of the learning biologic information templates stored in the memory unit with the biologic information in response to the determination that the biologic information is accepted by the determining unit.

This program is executed by the computer, so that the computer can be operated as the biometric apparatus. As a result, the computer can realize the similar effect to that of the above-described biometric apparatus.

A biometric apparatus according to a third aspect of the present invention includes a memory unit and a determining unit. The memory unit stores a plurality of biologic information templates for biometrics. The determining unit accepts biologic information for biometrics, calculates a plurality of matching scores showing the degree of similarity with respect to the plurality of biologic information templates, and determines whether the biologic information is accepted based on the plurality of matching scores to output a signal showing the determined result. The plurality of biologic information templates include a registration biologic information template which is registered in a fixed manner, and learning biologic information templates to be replaced at the time of operating the biometric apparatus. The biometric apparatus further includes a selecting unit, a number-of-selection-times accumulating unit and a replacing unit. The selecting unit selects a learning biologic information template whose matching score calculated by the determining unit is the smallest in response to the determination that the biologic information is accepted by the determining unit. The number-of-selection-times accumulating unit adds a predetermined value to data about the number of selection times correlated with the learning biologic information template selected by the selecting unit. The replacing unit determines whether a learning biologic information template where the data about the number of selection times to which the value is added by the number-of-selection-times accumulating unit is larger than a predetermined standard value is present in response to the determination that the biologic information is accepted by determining unit, and when being present, replaces this learning biologic information template with the biologic information determined as being accepted by the determining unit.

The memory unit stores the registration biologic information template and the learning biologic information templates therein in advance. When biologic information is given, the determining unit verifies (compares) the registration biologic information template and the learning biologic information templates with the given biologic information, and calculates matching scores showing the degree of similarity between them. Further, the determining unit determines whether the given biologic information is accepted based on the matching scores to output a signal showing the determined result. Since the plurality of templates are used to carry out the verifying (comparing), the reliability of the checked result becomes higher than the case where a single template is used. When the determining unit determines that the biologic information is accepted, the selecting unit selects a learning biologic information template having the smallest matching score, and the number-of-selection-times accumulating unit adds a predetermined value to the data about the number of selection (matching) times correlated with the selected learning biologic information template. When a learning biologic information template whose number of selection times is larger than a predetermined standard value is present, the replacing unit replaces the learning biologic information template with new biologic information.

Since a learning biologic information templates are updated in such a manner, the learning biologic information template, where number of times at which its degree of similarity with respect to the latest biologic information is lower than the others is larger than the predetermined standard value, is replaced with new biologic information. Therefore, the learning biologic information template whose difference from the latest biologic information becomes larger is eliminated, and the learning biologic information template whose difference from the latest biologic information is stably small remains. For this reason, the latest biologic information is always reflected to the learning biologic information templates. Even when the biologic state changes according to a change in an external condition such as a seasonal condition, a risk of accidentally rejecting biologic information to be accepted is reduced. The registration biologic information template, among the biologic information templates, is not replaced with new biologic information. For this reason, when biologic information to be rejected is accidentally accepted, not all the biologic information templates are replaced with other person's biologic information, and thus its influence is limited. As a result, it is possible to provide a biometric apparatus which can authenticate an identical person with high reliability according to a change in biologic information due to an external condition, and can improve its operability.

A biometric apparatus according to a fourth aspect of the present invention includes a memory unit and a determining unit. The memory unit stores a plurality of biologic information templates for biometrics. The determining unit accepts biologic information for biometrics, calculates a plurality of matching scores showing the degree of similarity with respect to the plurality of biologic information templates, and determines whether the biologic information is accepted based on the plurality of matching scores to output a signal showing the determined result. The plurality of biologic information templates include a registration biologic information template registered in a fixed manner, and learning biologic information templates to be replaced at the time of operating the biometric apparatus. The biometric apparatus further includes a selecting unit, a number-of-selection-times accumulating unit, a number-of-selection-times determining unit, and a replacing unit. The selecting unit selects a learning biologic information template whose matching score calculated by the determining unit is the largest in response to the determination that the biologic information is accepted by the determining unit. The number-of-selection-times accumulating unit adds a predetermined value to data about the number of selection times correlated with the learning biologic information template selected by the selecting unit. The number-of-selection-times determining unit determines whether a learning biologic information template, where the data about the number of selection times to which the value is added by the number-of-selection-times accumulating unit is smaller than the data about the number of selection times of any other learning biologic information templates and an absolute value of the difference is larger than a predetermined value, is present in response to the determination that the biologic information is accepted by the determining unit. When the number-of-selection-times determining unit determines that the learning biologic information template which satisfies the determining condition is present, the replacing unit replaces this learning biologic information template with the biologic information determined as being accepted by the determining unit.

When the determining unit determines that the biologic information is accepted and the number-of-selection-times determining unit determines that the data about the number of times accumulated by the number-of-selection-times accumulating unit is smaller than any other data about the number of selection times by not less than a predetermined number of times, in response to this, the replacing unit replaces the learning biologic information template correlated with the data about the number of selection times with new biologic information. That the data about the number of selection times of a certain learning biologic information template is smaller than the data about the number of selection times of another learning biologic information template means that this learning biologic information template is more different from inputted biologic information. That is to say, it is considered that this learning biologic information template is different from recent biologic information acquired from the user, and represents biologic information in an old state. Therefore, such a learning biologic information template is replaced with the latest biologic information, and the latest user's biologic information is reflected to the learning biologic information template. As a result, it is possible to provide a biometric apparatus which, even if biologic information changes due to an external condition, reflects the change to the learning biologic information templates, and thus authenticates an identical person with high reliability to improve its operability.

A biometric apparatus according to a fifth aspect of the present invention includes a memory unit and a determining unit. The memory unit stores a plurality of biologic information templates for biometrics. The determining unit accepts biologic information for biometrics, calculates a plurality of matching scores showing the degree of similarity with respect to the plurality of biologic information templates, and determines whether the biologic information is accepted based on the plurality of matching scores to output a signal showing the determined result. The plurality of biologic information templates include a registration biologic information template registered in a fixed manner, and leaning biologic information templates to be replaced at the time of operating the biometric apparatus. The biometric apparatus further includes a selecting unit, a number-of-selection-times accumulating unit, a number-of-selection-times determining unit, and a replacing unit. The selecting unit selects a learning biologic information template whose matching score calculated by the determining unit is the smallest in response to the determination that the biologic information is accepted by the determining unit. The number-of-selection-times accumulating unit adds a predetermined value to data about the number of selection times correlated with the learning biologic information template selected by the selecting unit. The number-of-selection-times determining unit determines whether a learning biologic information template, where the data about the number of selection times to which the value is added by the number-of-selection-times accumulating unit is larger than the data about the number of selection times of any other learning biologic information templates and an absolute value of the difference is larger than a predetermined value, is present in response to the determination that the biologic information is accepted by the determining unit. When the number-of-selection-times determining unit determines that a learning biologic information template which satisfies the determining condition is present, the replacing unit replaces this learning biologic information template with the biologic information determined as being accepted by the determining unit.

When the determining unit determines that the biologic information is accepted and the number-of-selection-times determining unit determines that the data about the number of selection times accumulated by the number-of-selection-times accumulating unit is larger than any other data about the number of selection times by not less than a predetermined number of times, in response to this, the replacing unit replaces the learning biologic information template correlated with the data about the number of selection times with new biologic information. That the data about the number of selection times of a certain learning biologic information template is larger than the data about the number of selection times of another learning biologic information template means that this learning biologic information template is more different from inputted biologic information. That is to say, it is considered that this learning biologic information template is different from recent biologic information acquired from the user, and shows biologic information in an old state. Therefore, such a learning biologic information template is replaced with the latest biologic information, and the latest user's biologic information is reflected to the learning biologic information template. As a result, it is possible to provide a biometric apparatus which, even if biologic information changes due to an external condition, reflects the change to the learning biologic information templates, and thus authenticates an identical person with high reliability to improve its operability.

The biometric apparatus may further include an initializing unit which initializes the data about the number of selection times to be added by the number-of-selection-times accumulating unit with a predetermined value in response to the replacement of the learning biologic information template with new biologic information by the replacing unit.

At every replacement, the number of selection times is newly initialized. A previous selected result is not carried over, and the number of selection times is added to the learning biologic information templates under the same condition. Therefore, also the learning biologic information template acquired from the latest biologic information is updated under the same condition as that for the previously existing learning biologic information templates, and thus does not bring about disadvantages. The learning biologic information templates are maintained in the latest state in response to the change in biologic information. As a result, it is possible to provide a biometric apparatus which can authenticate an identical person with high reliability according to the change in biologic information due to an external condition, and can improve its operability.

When a biometric program according to a sixth aspect of the present invention is executed by a computer, the computer serves as a memory unit and a determining unit. The memory unit stores a plurality of biologic information templates for biometrics. The determining unit accepts biologic information for biometrics, calculates a plurality of matching scores showing the degree of similarity with respect to the plurality of biologic information templates, and determines whether the biologic information is accepted based on the plurality of matching scores to output a signal showing the determined result. The plurality of biologic information templates include a registration biologic information template registered in a fixed manner, and learning biologic information templates to be replaced at the time of operating the biometric program. The biometric program further causes the computer to function as a selecting unit, a number-of-selection-times accumulating unit and a replacing unit. The selecting unit selects a learning biologic information template whose matching score calculated by the determining unit is the smallest in response to the determination that the biologic information is accepted by the determining unit. The number-of-selection-times accumulating unit adds a predetermined value to data about the number of selection times correlated with the learning biologic information template selected by the selecting unit. The replacing unit determines whether a learning biologic information, where the data about the number of selection times to which the value is added by the number of selection times accumulating unit is larger than a predetermined standard value, is present in response to the determination that the biologic information is accepted by the determining unit, and when present, replaces the learning biologic information template with the biologic information determined as being accepted by the determining unit.

When this program is executed by the computer, the computer can be operated as the biometric apparatus according to the third aspect. As a result, the computer can realize the similar effect to that of the biometric apparatus according to the third aspect.

### CONCLUSION

The present invention is described in part above by examples involving fingerprint authentication. However, the present invention is not limited to the biometrics using fingerprints, and may be applied in authentication systems which retain a number of templates for biometrics, for example, and/or which compare matching scores showing the degree of similarity between input information and templates so as to authenticate an identical person. For example, the present invention can be applied to biometrics using palm shape, face, iris, voice pattern, hand or arm vascular pattern, signature, a change in writing pressure at the time of signature and retina pattern in addition to the fingerprints. An algorithm can be used as the verifying algorithm of the biologic information so long as it is used for calculating scores for verification.

All or some of the functions which are the constitutional requirement of the present invention can be realized by hardware configured by a logic circuit. Further, firmware which realizes the above functions may be incorporated into the embedded devices, so that the biometric apparatus can be realized.

The embodiments disclosed herein are simply examples, and the present invention is not limited only to the above embodiments. The scope of the present invention is defined by the claims taking the detailed description of the invention into consideration, and covers all changes within the scope of meanings equivalent to the sentences described therein.

Although particular embodiments are expressly illustrated and described herein as methods or systems, it will be appreciated that discussion of one type of embodiment also generally extends to other embodiment types. For instance, the descriptions of methods in connection with FIGS. 4-7, 10, and 11 also help describe systems like those described in connection with FIGS. 1-3, and vice versa. Likewise, example method embodiments help describe system embodiments that operate according to those methods, product embodiments produced by those methods (such as a set of biometric information templates 190), and configured media embodiments in which a medium (such as memories 118, 120, hard disc 114, and/or DVD 122) is configured by data and instructions to perform those methods. It does not follow that all limitations from a given embodiment are necessarily read into another. Components, steps, and other aspects of different examples given herein may be combined to form a given embodiment.

Reference has been made to the figures throughout by reference numerals. Any apparent inconsistencies in the phrasing associated with a given reference numeral, in the figures or in the text, should be understood as simply broadening the scope of what is referenced by that numeral.

As used herein, terms such as “a” and “the” are inclusive of one or more of the indicated item or step. In particular, in the claims a reference to an item generally means at least one such item is present and a reference to a step means at least one instance of the step is performed.

Headings are for convenience only; information on a given topic may be found outside the section whose heading indicates that topic.

All claims as filed are part of the specification. Repeated claim language may be inserted outside the claims as needed.

While exemplary embodiments have been shown in the drawings and described above, it will be apparent to those of ordinary skill in the art that numerous modifications can be made without departing from the principles and concepts set forth in the claims. Although the subject matter is described in language specific to structural features and/or methodological acts, it is to be understood that the subject matter defined in the appended claims is not necessarily limited to the specific features or acts described above the claims. It is not necessary for every means or aspect identified in a given definition or example to be present or to be utilized in every embodiment. Rather, the specific features and acts described are disclosed as examples for consideration when implementing the claims.

All changes which come within the meaning and range of equivalency of the claims are to be embraced within their scope to the full extent permitted by law.

What is claimed is:

1. A biometric apparatus comprising:
a memory unit storing a registration biologic information template which is fixed and at least one learning biologic information template which is subject to replacement; and
a determining unit capable of operating in connection with the memory unit to:
receive an inputted biologic information,
calculate a plurality of matching scores showing a respective degree of similarity between an inputted biologic information and each of a plurality of biologic information templates,
determine whether the inputted biologic information is accepted based on the plurality of matching scores, and
output a signal showing whether the inputted biologic information is accepted.

2. The apparatus of claim 1, wherein the memory unit stores a plurality of learning biologic information templates, and the determining unit calculates matching scores for each of a plurality of learning biologic information templates.

3. The apparatus of claim 1, further comprising a template learning unit capable of operating in connection with the memory unit and the determining unit to replace a learning biologic information template stored in the memory unit with the inputted biologic information in response to a determination of acceptance of the inputted biologic information by the determining unit.

4. The apparatus of claim 3, wherein the template learning unit operates to replace the learning biologic information template which has a matching score indicating a least degree of similarity between the learning biologic information template and the inputted biologic information.

5. The apparatus of claim 1, wherein the determining unit is further capable of operating in connection with the memory unit to calculate an average score as an average value of the matching scores and to determine whether the inputted biologic information is accepted based on whether the average score indicates at least a predetermined average degree of similarity.

6. The apparatus of claim 1, wherein the determining unit is further capable of operating in connection with the memory unit to calculate an average score as an average value of the matching scores and to determine whether the inputted biologic information is accepted based firstly on whether the average score indicates at least a predetermined average degree of similarity, and based secondly on whether each of the matching scores indicates at least a respective predetermined individual degree of similarity.

7. The apparatus of claim 1, further comprising a template registration unit which registers the registration biologic information template and the at least one learning biologic information template in the memory unit, such that the registration biologic information template cannot be replaced during normal operation of the apparatus and the at least one learning biologic information template can be replaced during normal operation of the apparatus.

8. The apparatus of claim 1, wherein the determining unit is further capable of operating in connection with the memory unit to select a learning biologic information template whose matching score is an extreme after the inputted biologic information is accepted by the determining unit, and to accumulate data based on the number of times a given learning biologic information template is selected.

9. A method for biometric authentication, comprising the steps of:
obtaining a biologic information input which is to be accepted or rejected as being input from an authentic user;
calculating a matching score which shows a degree of similarity between the biologic information input and a fixed registration biologic information template;
for each of one or more non-fixed learning biologic information templates, calculating a matching score which shows a degree of similarity between the biologic information input and the learning biologic information template;
determining whether the biologic information input is accepted as input from an authentic user based on the matching scores; and
outputting a signal showing whether the biologic information input is accepted as input from an authentic user.

10. The method of claim 9, further comprising the step of replacing a learning biologic information template with a biologic information input which has been accepted as input from an authentic user.

11. The method of claim 10, wherein the replacing step replaces the learning biologic information template which has a matching score indicating the least degree of similarity with the biologic information input.

12. The method of claim 9, wherein the method further comprises calculating an average matching score as an average value of the matching scores, and the determining step determines whether the biologic information input is accepted as input from an authentic user based on whether the average matching score indicates at least a predetermined average degree of similarity.

13. The method of claim 9, wherein the method further comprises calculating an average matching score as an average value of the matching scores, and the determining step determines whether the biologic information input is accepted as input from an authentic user based on whether two conditions hold, namely, the average matching score indicates at least a predetermined average degree of similarity, and each of the matching scores indicates at least a respective predetermined individual degree of similarity.

14. The method of claim 9, wherein the method further comprises the steps of:
selecting a learning biologic information template based on its matching score;
incrementing a selection-times counter associated with the selected learning biologic information template;
replacing a learning biologic information template whose selection-times counter satisfies a predetermined condition; and
initializing the selection-times counter of the replaced learning biologic information template.

15. The method of claim 9, wherein the method further comprises the steps of:
selecting a learning biologic information template whose matching score, of all the current matching scores, indicates the least degree of similarity with biologic information input;
incrementing a selection-times counter associated with the selected learning biologic information template; and
replacing a learning biologic information template whose selection-times counter satisfies a predetermined condition.

16. The method of claim 15, wherein the selection-times counter satisfies at least one of the following predetermined conditions: (a) the selection-times counter is larger than a predetermined standard value, (b) the selection-times counter has the largest value of the current selection-times counters, (c) the selection-times counter has the largest value of the current selection-times counters and also the absolute value of the difference between the largest selection-times counter and the next largest selection-times counter is larger than a predetermined value.

17. The method of claim 9, wherein the method further comprises the steps of:
selecting a learning biologic information template whose matching score, of all the current matching scores, indicates the greatest degree of similarity with biologic information input;
incrementing a selection-times counter associated with the selected learning biologic information template; and
replacing a learning biologic information template whose selection-times counter satisfies a predetermined condition.

18. The method of claim 17, wherein the selection-times counter satisfies at least one of the following predetermined conditions: (a) the selection-times counter is smaller than a predetermined standard value, (b) the selection-times counter has the smallest value of the current selection-times counters, (c) the selection-times counter has the smallest value of the current selection-times counters and also the absolute value of the difference between the smallest selection-times counter and the next smallest selection-times counter is larger than a predetermined value.
